(19) United States
(12) Patent Application Publication
(10) Pub. No.: US 2026/0193872 A1
(43) Pub. Date: Jul. 9, 2026

(54) SANITARY SYSTEM

(71) Applicant: GEBERIT INTERNATIONAL AG, Jona (CH)

(72) Inventor: Daniel RAISSLE, Altendorf (CH)

(73) Assignee: GEBERIT INTERNATIONAL AG, Jona (CH)

(21) Appl. No.: 19/133,497

(22) PCT Filed: Nov. 23, 2023
(86) PCT No.: PCT/EP2023/082892

§ 371 Date: May 28, 2025

(30) Foreign Application Priority Data
Dec. 22, 2022 (EP) 22215829.7

(51) Int. Cl. E03C 1/05; H04L 12/44

(52) U.S. Cl. CPC E03C 1/055; H04L 12/44

(57) ABSTRACT

A sanitary system having a plurality of sanitary elements, each of which has a communication interface on the sanitary element side, and at least one gateway which has a gateway-side communication interface, a memory and a processor, the memory and processor being operatively connected to one another and to the gateway-side communication interface. The at least one gateway is connected via the gateway-side communication interface to the sanitary element-side communication interface via a data connection. The data connection is designed as a direct data connection and is configured such that data can be exchanged between the gateway and the sanitary element via the data connection. The memory of the gateway is designed to store at least one logical group to which at least one selection from all sanitary elements connected to the gateway is assigned.

### TECHNICAL FIELD

The present invention relates to a sanitary system according to claim 1 and to an arrangement comprising a sanitary system according to claim 18.

### PRIOR ART

Networked sanitary systems are known from the prior art. For example, DE 93 13 983 U1 discloses a control system for various sanitary elements comprising a central control unit.

### SUMMARY OF THE INVENTION

Based on this state of the art, the present invention is based on a task of specifying a sanitary system which comprises extended functionalities.

The sanitary system according to claim 1 solves these and other tasks. The sanitary system comprises
a plurality of sanitary elements, which have a communication interface on the sanitary element side, and
at least one gateway which has a gateway-side communication interface, a memory and a processor, the memory and processor being operatively connected to one another and to the gateway-side communication interface,

The at least one gateway is connected via the gateway-side communication interface to the sanitary element-side communication interface via a data connection. The data connection is designed as a direct data connection. The data connection is configured in such a way that data can be exchanged between the gateway and the sanitary element via the data connection. Depending on the design of the sanitary element, data can be exchanged bidirectionally or unidirectionally from the sanitary element to the gateway. The memory of the gateway is designed to store at least one logical group to which at least one selection from all sanitary elements connected to the gateway is assigned.

The advantage of storing the logical groups at the gateway level is that the sanitary system can be scaled as required.

For example, the sanitary system can be designed as a small sanitary system in which there is only one gateway, with all sanitary elements being connected to the gateway. Such a small sanitary system can be used in a single-family house, for example.

However, the sanitary system can also be designed as a larger sanitary system in which a plurality of gateways is present. The gateways can be connected to a computer network in an arrangement as described below.

Another advantage of grouping is that each gateway can function, independently of other gateways or higher-level structures, such as the computer network mentioned below, with the sanitary elements connected to the gateway and grouped at gateway level.

The advantage of group storage at the gateway level is that fewer data points need to be configured in a larger sanitary system because the gateway as such provides a data point which has already grouped the sanitary elements combined into groups. As explained further below, the gateway can also provide a group of data points. This makes it easier to set up larger sanitary systems because there are fewer data points to configure.

A direct data connection is understood to mean that the connection between the gateway and the sanitary elements connected to it is formed without an intermediate connection with other electronic components.

Another advantage of the grouping is that it can improve the clarity of larger sanitary facilities. For example, an alarm or fault message of a sanitary element can be displayed together with the corresponding group, making it much easier to find on site.

The expression “at least one selection” means that all sanitary elements connected to the gateway are grouped together in the group or that only a selection of all sanitary elements connected to the gateway are grouped together in a group.

Preferably, the processor is configured to combine at least one selection from all the sanitary elements connected to the gateway into at least one logical group. This means that the logical group is created directly on the gateway.

Preferably, the logical group is formed according to the type of sanitary elements and/or according to the placement of the sanitary elements in relation to each other, in particular in local or functional relation, and/or according to the function of the sanitary elements.

When placing the sanitary elements, for example, all sanitary elements in a sanitary room can be given an ascending number. This makes it easier to keep an inventory and find them.

When grouping according to the type of sanitary element, all sanitary elements of the same type can be grouped together. For example, the following groups can be formed in a larger sanitary room:
urinal group with all urinals connected to the gateway
toilet group with all toilets connected to the gateway
washbasin group with all washbasins connected to the gateway

Preferably, several logical groups are formed, wherein the several logical groups are combined to form a supergroup.

The supergroup is, for example, a men's sanitary room, whereby the urinal group, the toilet group and the washbasin group are combined in this supergroup; or a women's sanitary room, whereby the toilet group and the washbasin group are combined in this supergroup.

In a multi-family house, for example, each apartment can represent a supergroup.

Preferably, the sanitary element has an identifier, whereby the identifier is assigned to at least one logical group.

The identifier can be a serial number and/or a sanitary element designation, for example. The sanitary element designation can comprise the type of the sanitary element, thus for example urinal, toilet or washbasin, and/or a product designation, such as Preda, Selva, Tamina, One, etc.

Preferably, the assignment to a logical group can be stored exclusively in the gateway, but not at the level of the sanitary elements. In other words, the information about the assignment to a group is only stored on the gateway. No such storage takes place on the sanitary element itself.

Preferably, the processor of the gateway is configured in such a way that the at least one logical group is combined automatically, in particular on the basis of predetermined criteria. In a particularly preferred embodiment, the sanitary system also comprises a computer, in particular a mobile computer, wherein the computer comprises a computer-side communication interface and wherein the gateway has a further communication interface. A data connection can be provided between the computer-side communication interface and the further communication interface. The computer provides a user interface which is configured in such a way that a user can perform said grouping manually.

Preferably, the computer is a cell phone, a tablet, a notebook, etc. The user interface is typically provided by a screen and corresponding input elements.

Preferably, the grouping is performed as part of the direct data connection between the gateway and the sanitary element. This means that the computer only provides the user interface and the grouping is processed at the gateway level.

Alternatively, the computer may have a processor which is configured to combine at least one selection from all the sanitary elements connected to the gateway into at least one logical group. The logical group can be transmitted to the gateway as a data set via the data connection between the gateway and the computer. Furthermore, the logical group can be stored in the gateway's memory.

Preferably, the user interface is configured in such a way that said sanitary elements are displayed on the user interface in such a way that a user can automatically group the sanitary elements to be grouped together. The grouping is carried out by a user input.

Preferably, typical operating data for the sanitary element, such as water consumption and/or number of actuations, is transmitted from the sanitary element to the gateway via the data connection between the gateway and the sanitary elements.

Preferably, the processor of the gateway is configured in such a way that the operating data of the group can be processed.

The operating data can therefore be consolidated at the gateway level. For example, it is conceivable that the operating data could be totaled at the gateway level.

Preferably, the sanitary element comprises an actuator, wherein the sanitary element controller is configured to control the actuator as intended; and/or wherein the sanitary element comprises a sensor for measuring a physical quantity. The sanitary element controller or the sensor, respectively, comprise said control system on the sanitary element side.

The term “sanitary element” refers to all elements to be placed in a sanitary room. In particular, the term “sanitary element” refers to a flush for a urinal or a toilet, a sanitary fitting for a washbasin or a shower, an actuator plate, a mounting frame with integrated sanitary element actuator, a shower toilet and/or a shower toilet attachment. However, the sanitary element can also be a sensor arranged in a sanitary room. This means, for example, that environmental data such as air temperature, humidity, user frequencies, water temperatures, etc. can be recorded by the sensor and evaluated accordingly in the sanitary system.

Preferably, a plurality of sanitary elements are arranged in a sanitary system.

Once the data connection has been established, the gateway automatically detects the sanitary element(s) connected to the gateway and maintains the data connection.

Preferably, the sanitary system also comprises at least one input element with a communication interface on the input element side and at least one manually operable actuating element. When the actuating element is actuated, a control signal can be transmitted to the gateway via the communication interface on the input element side. The input element is assigned to at least one of the aforementioned at least one logical group. The control signal can be processed by the processor in the gateway and made available to said at least one logical group to which the input element is assigned.

The input element is preferably formed separate from the sanitary articles.

The input element can be designed in various ways. It is particularly preferable that the input element is an input element which can only be actuated upon presentation of proof of authorization. For example, the input element is a key switch which can be actuated with a key, or a code field which can be actuated by entering a correct code, or a fingerprint reader which can be actuated by recognizing a fingerprint of an authorized person.

The communication interface on the input element side can be connected to the communication interface on the gateway side via a data connection. The data connection can be provided in the same way or similar way, respectively, as the data connection between the sanitary elements and the gateway. Alternatively, the data connection between the communication interface on the input element side and the gateway can also be established via the computer network described below.

Preferably, each group is assigned its own actuating element. However, it is also conceivable that one actuating element can be provided for several groups.

Preferably, the control signal represents a switch-on command, upon which the sanitary elements assigned to the logical group are switched on; and/or the control signal represents a switch-off command, upon which the sanitary elements assigned to the logical group are switched off.

Preferably, the sanitary element can provide at least one data point per sanitary element, whereby the data points can be stored in the memory of the gateway.

Preferably, a data point is information about a status of the sanitary element, for example the number of flushes or valve openings of the sanitary element.

Preferably, similar data points of sanitary elements which are assigned to a logical group can be summarized in a group of data points, assigned to the logical group and stored in the memory in connection with the logical group. For example, the number of flushes or valve openings of all sanitary elements can be summarized in a group.

It is particularly preferable that similar data points from several logical groups can be summarized in one data set and stored in the memory. For example, the number of flushes or valve openings of all sanitary elements in all or several logical groups can be summarized.

The arrangement also comprises a computer network, wherein the gateway comprises a further communication interface via which a data connection can be provided between the gateway and the computer network.

The computer network can be a cloud structure, a wireless or wired network and/or a building management system.

Preferably, the gateway provides a data point which is assigned to at least one logical group. This data point is made available to the computer network. The gateway and the at least one logical group can be addressed via the computer network via this data point. The advantage of integrating multiple gateways is that only one data point needs to be configured or connected per gateway, respectively, and that this data point is assigned to one or several groups.

Preferably, a processor is present in the computer network, said processor being configured to group at least one selection from all the sanitary elements connected to the gateway into at least one logical group. Once created, the logical group can be transmitted to the gateway as a data set via the data connection between the gateway and the computer network. The logical group can be stored in the gateway's memory.

This embodiment has the advantage that an installer with access to the computer network can form and/or control the group formation from a remote position, i.e. when not on site.

Preferably, several gateways are connected to the computer network, wherein the computer network is configured to exclusively group at least one selection of gateways from all gateways connected to the computer network into a logical group, but not to group sanitary elements connected to the gateways.

Further embodiments are given in the dependent claims.

### BRIEF DESCRIPTION OF THE DRAWINGS

Preferred embodiments of the invention are described below with reference to the drawings, which are for explanatory purposes only and are not to be construed restrictively. The drawings show, in:

FIG. 1 a schematic view of an embodiment of a sanitary facility according to the invention or an arrangement according to the invention, respectively;

FIG. 2 a schematic of a sanitary room whose sanitary elements have been grouped together with a sanitary facility;

FIG. 3 a schematic of two sanitary rooms whose sanitary elements have been grouped together with a sanitary facility;

FIG. 4 a schematic view of a further embodiment of a sanitary facility according to the invention or an arrangement according to the invention, respectively; and

FIG. 5 a schematic of a sanitary room, whose sanitary elements have been grouped with a sanitary facililty according to the second embodiment.

### DESCRIPTION OF PREFERRED EMBODIMENTS

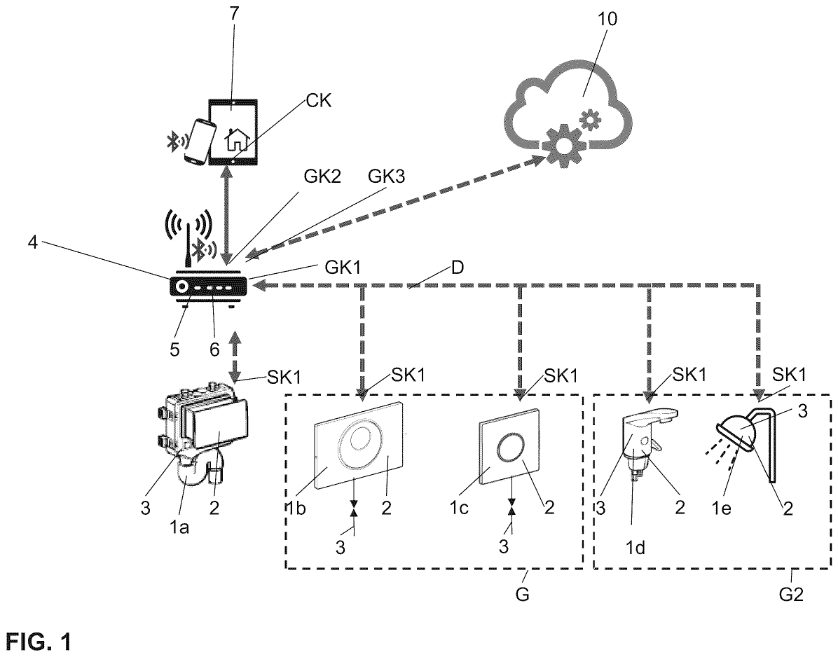

FIGS. 1, 2 and 3 schematically show an embodiment of a sanitary system of a first embodiment. The sanitary system comprises several sanitary elements 1a, 1b, 1c, 1d, 1e, 1f and at least one gateway 4.

The sanitary elements 1a, 1b, 1c, 1d, 1e, 1f are shown as examples in the figures. The sanitary element 1a is a cistern with a flush valve as an actuator. The cistern can also have a hygienic flush valve. The sanitary elements 1b and 1c are actuator plates for triggering the flushing of a toilet or of a urinal. The actuator plate 1b comprises a detection sensor and the actuator plate 1c comprises an actuation button. The sanitary element 1d is an outlet fitting for a washbasin and the sanitary element 1e is an outlet fitting for a shower. However, the sanitary element can also be provided by a sensor. Each of the sanitary elements 1a, 1b, 1c, 1d, 1e, 1f comprises a communication interface SK1 on the sanitary element side. Depending on the configuration, the sanitary element 1a, 1b, 1c, 1d, 1e, 1f comprises a sanitary element controller 2 and an actuator 3, wherein the sanitary element controller 2 is configured to control the actuator 3 as intended. The sanitary element can also comprise a sensor for measuring a physical quantity, such as a temperature or a flow rate.

The at least one gateway 4 comprises a gateway-side communication interface GK1, a memory 5 and a processor 6. The memory 5 and processor 6 are operatively connected to each other and to the gateway-side communication interface GK1. The operative connection is such that the functions described herein can be executed and that data can be processed.

The at least one gateway 4 is connected via the gateway-side communication interface GK1 to the sanitary element-side communication interface SK1 via a data connection D. Preferably, once the data connection D has been established, the gateway 4 will automatically detect the sanitary element(s) 1a, 1b, 1c, 1d, 1e, 1f connected to the gateway 4 and will maintain the data connection D. After detection, the group formation described herein can be carried out.

The data connection D is designed as a direct data connection and is configured in such a way that data can be exchanged between the gateway 4 and the sanitary element 1a, 1b, 1c, 1d, 1e, 1f via the data connection D. The data can be operating data, such as water consumption, number of actuations or control data.

The memory 5 of the gateway 4 is designed to store at least one logical group G, to which at least one selection from all sanitary elements 1a, 1b, 1c, 1d, 1e, 1f connected to the gateway 4 is assigned. Two groups G are symbolized in FIG. 1. The sanitary elements 1b and 1c are assigned to one group and the sanitary elements 1d and 1e are assigned to the other group. The sanitary element 1a is not assigned to any group. In other variants, it is also conceivable that all sanitary elements connected to the gateway 4 are assigned to a single group. As explained below, other types of assignment are also conceivable.

Preferably, the assignment to a logical group G can be stored exclusively in the gateway 4, but not at the level of the sanitary elements 1a, 1b, 1c, 1d, 1e, 1f. This has the advantage that no data is lost if the sanitary element fails.

In the embodiment shown, the sanitary system also comprises a computer 7. In particular, the computer 7 is a mobile computer. The computer 7 comprises a computer-side communication interface CK and the gateway 4 comprises a further communication interface GK2. A data connection can be provided between the computer-side communication interface CK and the further communication interface GK2. The computer 7 is either temporarily or always connected to the gateway 4. The computer 7 provides a user interface via which a user can make entries.

The processor 6 of the gateway 2 is preferably configured to combine at least one selection from all the sanitary elements 1a, 1b, 1c, 1d, 1e, 1f connected to the gateway 4 in at least one logical group G.

The grouping can, for example, be an automatic grouping according to predefined rules, which is carried out by the processor 6 itself.

On the other hand, grouping by a user is also conceivable. In this case, it is advantageous if the user can carry out the grouping via the user interface of a computer 7. The user interface is configured in such a way that a user can perform said grouping manually. In other words, the user interface is configured such that said sanitary elements 1a, 1b, 1c, 1d, 1e, 1f are displayed such that a user can automatically combine the sanitary elements 1a, 1b, 1c, 1d, 1e, 1f to be grouped into a group.

Via the data connection D between the gateway 4 and the sanitary elements 1a, 1b, 1c, 1d, 1e, 1f, typical operating data for the sanitary element 1a, 1b, 1c, 1d, 1e, 1f, such as water consumption and/or number of actuations, can be transmitted from the sanitary element 1a, 1b, 1c, 1d, 1e, 1f to the gateway 4. This operating data can then be summarized on the gateway 4 according to the individual groups G, in a group-by-group manner.

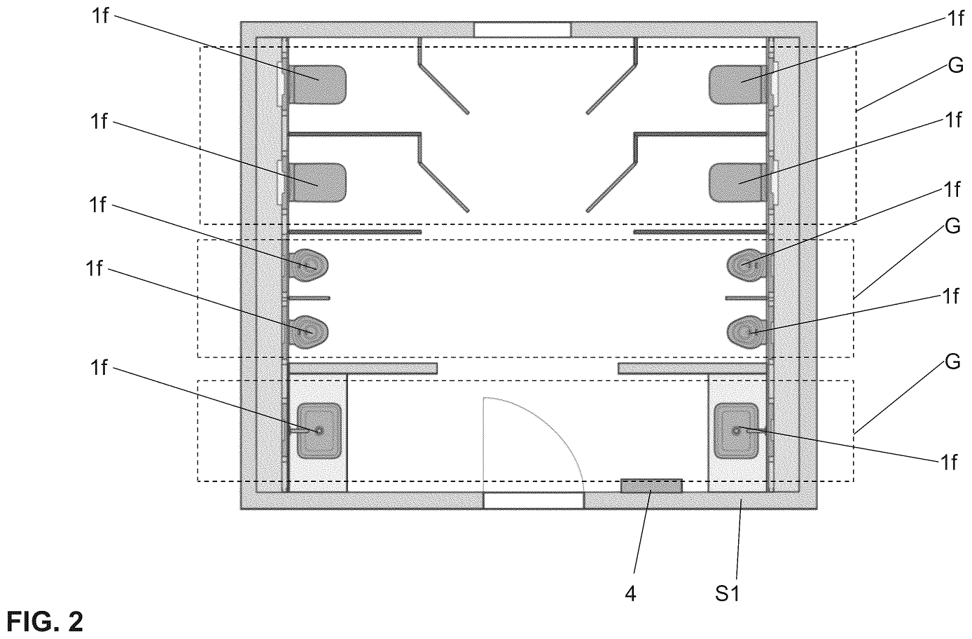

FIG. 2 shows a sanitary room S1 with various sanitary elements 1f. There are four toilets, four urinals and two washbasins. The sanitary elements 1f comprise elements which enable the intended use. For example, a cistern with a flush valve and a control element. The sanitary elements 1f are connected to the gateway 4 via the data connection not shown in FIG. 2. In the embodiment shown, all toilets have been combined in one group G, all urinals in another group G and all washbasins in a third group G.

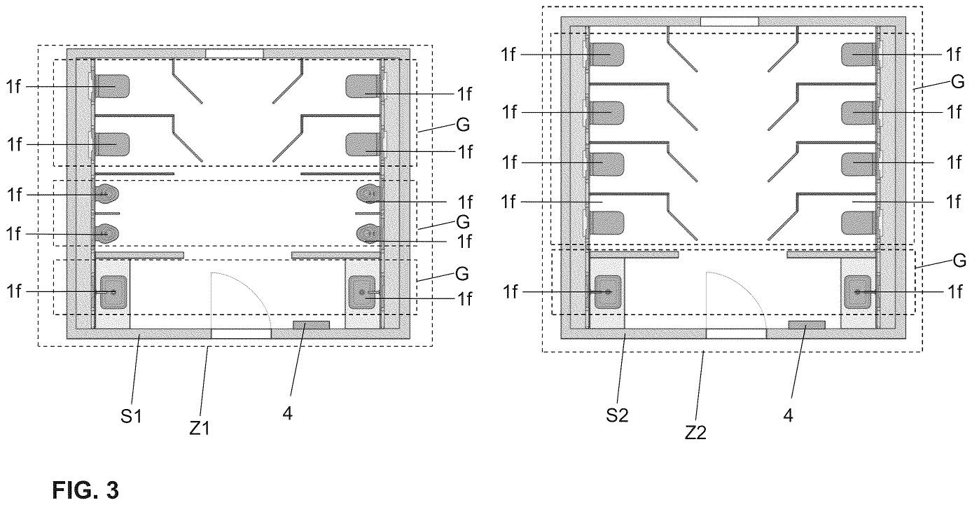

In addition to the sanitary room S shown in FIG. 2, another sanitary room S2 is shown in FIG. 3. The further sanitary room S2 has no urinals here. The toilets in the second sanitary room are grouped together in a group G and the washbasins are grouped together in another group G. Furthermore, all groups in the first sanitary room S1 are grouped together in a supergroup Z1 and all groups in the second sanitary room S2 are grouped together in a supergroup Z2.

FIG. 1 also shows the sanitary system in combination with an arrangement: The arrangement comprises a sanitary system 1 as described above and a computer network 10. The gateway 4 has a further communication interface GK3, via which a data connection can be provided between the gateway 4 and the computer network 10.

Preferably, a processor is present in the computer network 10, which processor is configured to group at least one selection from all sanitary elements 1a, 1b, 1c, 1d, 1e, 1f connected to at least gateway 4 in at least one logical group G. The grouping can therefore also be carried out in the computer network 10. The logical group can be transmitted to the gateway as a data set via the data connection between the gateway and the computer network, whereby the logical group can be stored in the memory 5 of the gateway 4.

The computer network may be in communication with a plurality of gateways, wherein the computer network is configured to exclusively group at least a selection of gateways from all gateways connected to the computer network into a logical group, but not to group sanitary elements connected to the gateways.

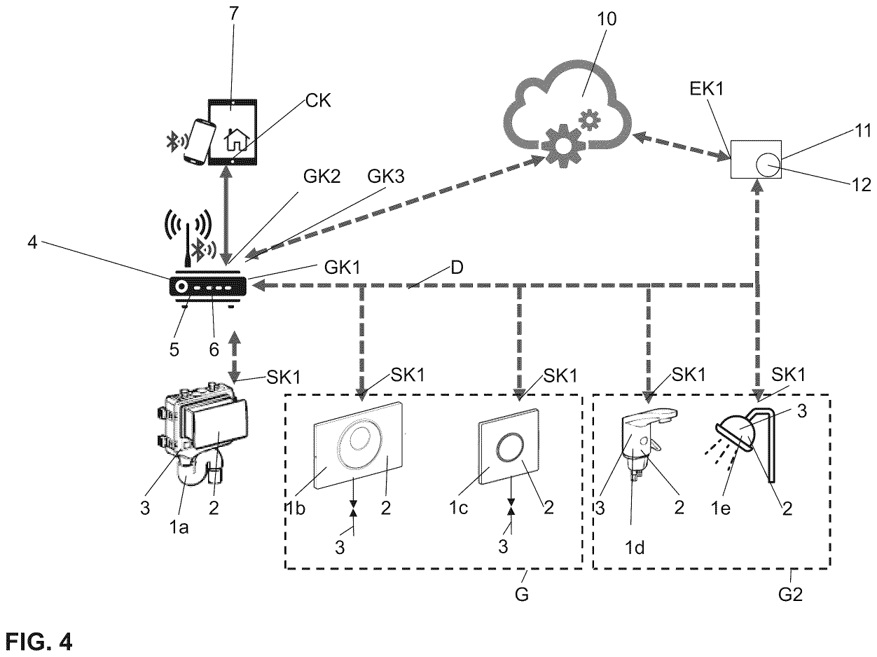

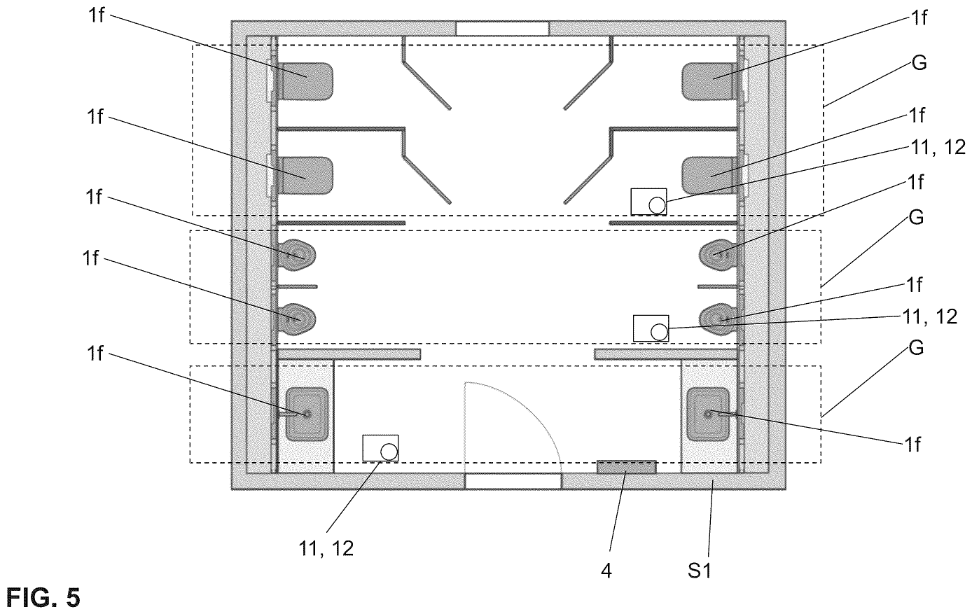

FIGS. 4 and 5 show a further embodiment of the sanitary system. The further embodiment comprises the elements of the first embodiment described above and at least one input element 1. Therein, identical elements are provided with identical reference signs and reference is made to the above description.

The at least one input element 11 comprises an input element-side communication interface EK1 and at least one manually operable actuating element 12. The at least one input element 11 is a physical input element which can be manually actuated by a user. The input element 11 can be integrated into the sanitary system in various ways. In one variant, the input element-side communication interface EK1 is connected to the first gateway-side communication interface GK1, just like the sanitary elements 1a-1f. In another variant, the input element-side communication interface EK1 is connected to the computer network 10, which in turn is connected to the gateway 4. When the actuating element 12 is actuated, a control signal can be transmitted to the gateway 4 via the input element-side communication interface EK1.

Furthermore, the input element 11 is assigned to at least one of the aforementioned at least one logical group. FIG. 4 shows that in each case one input element 11 is assigned to each logical group. However, it is also conceivable that only one or only some of the logical groups comprise an input element 11. The control signal from the at least one input element 11 can be processed by the processor in the gateway 4 and can be made available to said at least one logical group to which the input element is assigned.

Preferably, the control signal represents a switch-on or switch-off command. The sanitary elements assigned to the logical group can be switched on with the switch-on command. The switch-off command can be used to switch off the sanitary elements assigned to the logical group. This type of command is particularly advantageous, as a cleaner can switch the sanitary items off and on again as a group for a cleaning process.

### LIST OF REFERENCE SIGNS

1a-f sanitary elements
2 sanitary element control
3 actuator
4 gateway
5 memory
6 processor
7 computer
10 computer network
11 input element
12 actuating element
CK computer-side
   communication interface
SK1 communication interface on
   the sanitary element side
GK1, 2, 3 gateway-side communication
   interface
G group
S1, S2 sanitary room
Z1, Z2 supergroup

1-21. (canceled)

22. A sanitary system comprising
a plurality of sanitary elements, each of which comprises a sanitary element-side communication interface, and
at least one gateway which comprises a gateway-side communication interface, a memory and a processor, the memory and processor being operatively connected to one another and to the gateway-side communication interface,
wherein the at least one gateway is connected via the gateway-side communication interface to the sanitary element-side communication interface via a data connection,
wherein the data connection is designed as a direct data connection and is configured such that data can be exchanged between the gateway and the sanitary element via the data connection, and
wherein the memory of the gateway is designed to store at least one logical group to which at least one selection from all sanitary elements connected to the gateway is assigned.

23. The sanitary system according to claim 22, wherein the processor is configured to combine at least one selection from all sanitary elements connected to the gateway in at least one logical group.

24. The sanitary system according to claim 22, wherein the logical group is formed according to the type of sanitary elements and/or according to the placement of the sanitary elements in relation to one another and/or according to the function of the sanitary elements.

25. The sanitary system according to claim 22, wherein a plurality of logical groups are formed, wherein the plurality of logical groups are combined to form a supergroup.

26. The sanitary system according to claim 22, wherein each of the sanitary elements comprises an identifier, wherein the identifier is assigned to the at least one logical group.

27. The sanitary system according to claim 22, wherein the assignment to a logical group can be stored exclusively in the gateway, but not at the level of the sanitary elements.

28. The sanitary system according to claim 22,
wherein the processor is configured to combine at least one selection from all sanitary elements connected to the gateway in at least one logical group; and/or
wherein the logical group is formed according to the type of sanitary elements and/or according to the placement of the sanitary elements in relation to one another and/or according to the function of the sanitary elements; and/or
wherein a plurality of logical groups are formed, wherein the plurality of logical groups are combined to form a supergroup; and/or
wherein each of the sanitary elements comprises an identifier, wherein the identifier is assigned to the at least one logical group; and/or
wherein the assignment to a logical group can be stored exclusively in the gateway, but not at the level of the sanitary elements,
wherein the processor is configured such that the at least one logical group chosen from the mentioned logical groups is combined automatically, in particular on the basis of predetermined criteria.

29. The sanitary system according to claim 22, wherein the sanitary system furthermore has a computer, in particular a mobile computer, wherein the computer has a computer-side communication interface and wherein the gateway has a further communication interface, wherein a data connection can be provided between the computer-side communication interface and the further communication interface, and wherein the computer provides a user interface.

30. The sanitary system according to claim 29, wherein the user interface is configured such that said sanitary elements are displayed such that a user can automatically group the sanitary elements to be grouped together.

31. The sanitary system according to claim 22, wherein operating data typical for the sanitary element, such as water consumption and/or number of actuations, are transmitted from the sanitary element to the gateway via the data connection between the gateway and the sanitary elements.

32. The sanitary system according to claim 31, wherein the processor of the gateway is configured in such a way that the operating data of the group can be processed.

33. The sanitary system according to claim 22, wherein the sanitary element comprises an actuator, wherein the sanitary element controller is configured to control the actuator as intended; and/or wherein the sanitary element comprises a sensor for measuring a physical quantity.

34. The sanitary system according to claim 22, wherein, after the data connection has been established, the gateway automatically detects the sanitary element or elements connected to the gateway and maintains the data connection.

35. The sanitary system according to claim 22, wherein
the sanitary system further comprises at least one input element with an input element-side communication interface and with at least one manually operable actuating element,
wherein upon actuation of the actuating element, a control signal can be transmitted to the gateway via the input element-side communication interface,
wherein the input element is assigned to at least one of said at least one logical group,
and wherein the control signal can be processed by the processor in the gateway and can be made available to said at least one logical group to which the input element is assigned.

36. The sanitary system according to claim 35, wherein the control signal represents a switch-on command, upon which the sanitary elements assigned to the logical group are switched on; and/or wherein the control signal represents a switch-off command, upon which the sanitary elements assigned to the logical group are switched off.

37. The sanitary system according to claim 22, wherein at least one data point per sanitary element can be provided by the sanitary element, wherein the data points are storable in the memory of the gateway.

38. The sanitary system according to claim 37, wherein,
that similar data points of sanitary elements, which are assigned to a logical group, can be summarized in a group of data points, can be assigned to the logical group and can be stored in the memory in connection with the logical group; and/or
that similar data points from several logical groups can be combined in one data set and stored in the memory.

39. An arrangement comprising a sanitary system and a computer network,
said sanitary system comprising
a plurality of sanitary elements, each of which comprises a sanitary element-side communication interface, and
at least one gateway which comprises a gateway-side communication interface, a memory and a processor, the memory and processor being operatively connected to one another and to the gateway-side communication interface,
wherein the at least one gateway is connected via the gateway-side communication interface to the sanitary element-side communication interface via a data connection,
wherein the data connection is designed as a direct data connection and is configured such that data can be exchanged between the gateway and the sanitary element via the data connection,
wherein the memory of the gateway is designed to store at least one logical group to which at least one selection from all sanitary elements connected to the gateway is assigned; and
wherein the gateway comprises a further communication interface via which a data connection can be provided between the gateway and the computer network.

40. The arrangement according to claim 39, wherein the gateway provides a data point which is assigned to the at least one logical group, wherein this data point is made available to the computer network and wherein the gateway and the said groups can be addressed via the computer network via this data point.

41. The arrangement according to claim 39, wherein
a processor is present in the computer network, which processor is configured such that at least one selection from all the sanitary elements connected to the at least gateway is grouped in at least one logical group,
that the logical group can be transmitted to the gateway as a data set via the data connection between the gateway and the computer network,
and that the logical group can be stored in the memory of the gateway.

42. The arrangement according to claim 41, wherein a plurality of gateways are connected to the computer network, wherein the computer network is configured to exclusively group at least one selection of gateways from all gateways connected to the computer network into a logical group, but not to group sanitary elements connected to the gateways.
